(19) United States
(12) Patent Application Publication
(10) Pub. No.: US 2005/0049850 A1
(43) Pub. Date: Mar. 3, 2005

(54) Programmable timed action apparatus using audio and visual signals to interface with a human in completing a task oriented schedule

(76) Inventor: Sally Luanne Porter, Santa Ana, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/652,827

(22) Filed: Aug. 28, 2003

(51) Int. Cl. G06F 9/455

(52) U.S. Cl. 704/1; 700/11; 718/1

(57) ABSTRACT

A method for executing a programmable timed action apparatus using audio and visual signals to interface with a human in completing a task oriented schedule includes the steps of: recording an expected set of audio and visual signals associated with at least one task; announcing the start of the task; receiving clue signals during the duration of the task; providing prompting during the duration of the task; checking for received feedback to the prompting; checking if a fixed task duration has timed out; announcing that the task is in overtime when the task has timed out; checking if the task is completed; and announcing status of the task.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to devices for prompting action through audio or visual timed responses and more particularly to an electronic device using timing signals, audio signals and visual signals to adapt a program of action items.

2. Description of Related Art

The following art defines the present state of this field:
Horiuchi, U.S. Pat. No. Des. 307,305 describes a toy clock robot design.
Chen, U.S. Pat. No. Des. 336,856 describes a clock design.
Booty, Jr., U.S. Pat. No. Des. 357,634 describes a design for electronic assembly housing for alarm clocks, clock radios, table lamps or lights, and toys.
Rahamin et al., U.S. Pat. No. 4,228,470 describes an electronic reminder system for recording a plurality of different spoken messages on a record medium, which messages are to be played-back at a specific point-of-time for each message. The system comprises a microphone for recording the spoken messages, a keyboard for inputting data representing the specified point-of-time at which the respective spoken message is to be played-back, a real-time clock for measuring time in a real-time manner and for producing an output corresponding to such real-time measurement, control means controlled by the clock for signaling automatically the arrival of each specified point-of-time at which a recorded spoken message is to be played back, and a speaker for effecting the play-back of the spoken message.

Carmon et al., U.S. Pat. No. 4,258,354 describes a portable alarm embodying a plurality of actuatable warning devices, a clock generator for generating time signals and a selector for receiving a plurality of the time signal outputs, each corresponding to different times, and utilizing the selected time signal outputs along with a stored activation schedule to actuate selected warning devices. In a preferred embodiment, the portable alarm contains medicine storage means and the actuatable warning devices are visual indicators which indicate a particular medicine to be taken.

Takahashi, U.S. Pat. No. 4,406,549 describes an electronic timepiece with alarm function including a voice code memory for storing voice codes corresponding to externally coupled voices in accordance with write instruction signals corresponding to respective alarm times. The voice code memory includes a plurality of memory regions, and new voice codes are stored in a memory region immediately adjacent to the memory region in which voice codes are already stored. The voice codes read out from the voice code memory at the arrival of a predetermined alarm time are decoded for coupling to a sound producing unit to produce sound corresponding to the read out voice codes.

Bui et al., U.S. Pat. No. 4,573,187 describes a speech recognition and control apparatus, the speech signal is filtered into sub-bands, each sub-band signal sampled and binary quantized to form a digital string which is simplified (data reduced or compressed) by further encoding based on detecting in the string an isolated sample having one binary value surrounded by two samples having the other binary value.

Nishimuro et al., U.S. Pat. No. 4,698,783 describes an electronic equipment comprising a store for storing messages, apparatus for processing time information and generating an output at the beginning of each predetermined time period. The messages and time information may be displayed and one of the messages can be selected at random at the start of each time period and displayed with time information in response to the output of the time information processing means, the same message being prevented from being displayed more than once in a time period that is longer than the first mentioned time period.

Orthon et al., U.S. Pat. No. 5,184,959 describes a programmable device which emits an audible alarm to indicate one or more preselected toothbrushing times includes a display member set in a device housing, the housing having a number of toothbrush accommodating slots, each of the toothbrush-accommodating slots having an alarm switch associated therewith, the switch being disposed in an individual alarm circuit. The alarm switch is activated and reset by removal and insertion of the toothbrush into the slot.

Inoue et al., U.S. Pat. No. 4,715,010 describes an easy to use schedule alarm which is capable of sounding an alarm and displaying the content of a schedule or memorandum automatically without setting the alarm time or entering a data display instruction. With the scheduled data or memorandum being entered into the device in advance, it can notify the scheduled times by sounding an alarm and by displaying the contents of a schedule and memorandum thus serving to prevent one from leaving out scheduled times and data.

Hirayama, U.S. Pat. No. 4,780,839 describes an electronic schedule display apparatus comprising a key input section for inputting schedule data, the schedule data input by the key input section consisting of day data corresponding to date data, start time data, end time data, and content data of a scheduled event; a schedule data storage section for storing the schedule data input by the key input section, a matrix display device including a large number of optical matrix display elements arranged to correspond to a matrix table of days and times, one optical matrix display element of the matrix display device corresponding to several minutes, and one hour being constituted by the display elements smaller in number than 60, and a schedule time display control section for driving the display elements of the large number of optical matrix display elements of the matrix display device between one corresponding to the start time data of the schedule data stored in the schedule data storage section and one corresponding to the end time data of the schedule data.

Green, U.S. Pat. No. 5,288,233 describes a learning device for attention deficit children, having a wall mounted cabinet with an audio equipped model train located in a mirrored frontal surface, and sufficient timing devices to guide the child through a series of planned tasks, and having storage capability for associated task cards, listing pre-planned tasks, to be completed by the child, and storage space for negative correction cards, to be given to child upon non-completion of tasks. A slot is located on the side of the cabinet, and, when child successfully completes a task, in the time allowed, insertion of the corresponding card in the slot ejects a chip to the child, to be accumulated by the child, and, at certain periods of time, marked on a furnished calendar, the child is rewarded from a list of chosen rewards, each reward requiring a different number of chips, the rewards being weighted by importance to child.

Bissonnette et al., U.S. Pat. No. 5,602,963 describes a small, portable, hand-held electronic personal organizer that performs voice recognition on words spoken by a user to input data into the organizer and records voice messages from the user. The spoken words and the voice messages are input via a microphone. The voice messages are compressed before being converted into digital signals for storage. The stored digital voice messages are reconverted into analog signals and then expanded for reproduction using a speaker. The organizer is capable of a number of a different functions, including voice training, memo record, reminder, manual reminder, timer setting, message review, waiting message, calendar, phone group select, number retrieval, add phone number, security, and “no” logic. During such various functions, data is principally entered by voice and occasionally through use of a limited keypad, and voice recordings are made and played back as appropriate. A visual display provides feedback to the user. During the various function, the user can edit various different data within the organizer by eliminating or correcting such data or entering new data.

Abrams et al., U.S. Pat. No. 5,673,691 describes a hand-held computer that prepares and monitors a goal-oriented weight, nutrition and exercise control program. Visual and audio prompts tell users when to eat and exercise, and provide suggestions for what to eat. The computer assists the user in setting safe goals for desired weight loss and the time required to achieve the loss. The user follows menu and exercise programs suggested by the computer. The computer records and analyzes the user's food consumption, exercise and weight loss programs. Finally, the computer displays feedback information regarding the user's progress towards achieving the desired weight.

Heron, U.S. Pat. No. 6,042,383 describes a portable electronic device assists persons with learning disabilities and attention deficit disorders in performing daily living tasks. These tasks can include, e.g., making a bed, applying makeup, brushing teeth, getting dressed, and eating a meal, or hundreds of other tasks. The device is designed to allow users to develop a personal schedule of these tasks and special events. It alerts users at predetermined times to perform scheduled tasks and coaches and motivates the user in completing the tasks through text, audio and animation. The user is given a predetermined period of time to complete the task and rewarded with points if the task is completed on time. The device also records the user's performance of tasks and creates a task log of the user's performance over a given period of time.

Druckman et al., U.S. Pat. No. 6,109,925 describes a hand held electronic learning toy apparatus that reinforces learning by a user, such as a child, and provides motivation to the user to continue using the learning toy by enabling the user to interact with a plurality of game functions through one or more pre-programmed educational games and activities. The learning toy apparatus provides a tangible reward in the form of a colorful and/or interesting sticker when a question or query is answered correctly during the course of game play. Each sticker has an image of a single object, such as a star, ball, balloon, or the like, or includes indicia that is one segment of a larger picture wherein many stickers must be collected and pieced together to form the entire picture, much like a puzzle. Templates are provided that include indicia corresponding to the indicia of each sticker to indicate the proper placement of each sticker on the template.

Marchant, U.S. Pat. No. 6,515,239 describes a motivational apparatus for controlling use of an electronic device, wherein the apparatus is interconnected between a source of transmission (e.g. power) and the electronic device to control transfer of transmissions from the transmission source to the electronic device. The apparatus comprises a plurality of electrical switches, a master switch, and a plurality of light-emitting diodes. A list of tasks is prepared and associated with the electrical switches such that one task corresponds to one electrical switch. As each task is completed, the electrical switch corresponding to that task is actuated to light up the diode corresponding to that switch. After all of the tasks are completed, a parent or supervisor may confirm satisfactory completion of the tasks and then actuate the master switch to close the electrical circuit, thereby allowing transfer of transmissions from the transmission source to the electronic device such that the electronic device is operational.

Brooks, U.S. 2001/0035671 describes a learning chair that helps to teach a child important tools for life, such as how to tell time and days of the week, how to organize a daily wardrobe, and develop communication and organizational skills. The chair is shaped in the form of a fictional character or likable “buddy” to a child, such as a robot, doll, action figure, or cartoon character. A child learns how to prepare a daily wardrobe and vocabulary for placement of pants, dresses, shirts, hats, and shoes. The learning chair is a fun communication tool between a parent and child. The chair has the ability to play pre-recorded messages as alarms on a clock. Messages may be pre-recorded according to the voice of a fictional character portrayed by the chair, or pre-recorded by a parent or adult. Messages may include personal announcement using the child's name such as time to wake up, get dressed, go to bed, take a bath, etc. The chair has a chalkboard for leaving written messages between the parent and child. A child may also change the expressions on the face of the chair's character with removable facial indicia in the appearance of different moods. The chair is constructed of plastic or wood and has various hollowed compartments, drawers, and sacks for storage.

Task Solutions Pty. Ltd., WO 97/27555 describes a method of managing a plurality of tasks to be carried out by a plurality of personnel, each of the tasks having identified task details relevant thereto, in which the method includes: identifying task personnel who will be directly involved in carrying out each task; allocating sole responsibility for each task to a task controller, and transferring task details to and/or between task personnel and controllers such that task details relevant to a task are provided to and accessible by only the task controller and the task personnel for the task; wherein recommendations for modifying task details relevant to a task can only be made by task personnel for the task, and wherein a task or task details for a task can only be modified by the task controller for the task and/or an administrator, the method utilises a data processing assembly operable under the control of program means embodied on a machine-readable storage medium that provides a task management system for coordinating the plurality of tasks, and the task management system includes: transfer means for transferring the task details to and/or between the task personnel and controllers; recommendation protocol means for establishing a protocol that the recommendations for modifying task details relevant to a task can only be made by the task personnel for the task, and modification protocol means for establishing a protocol that the modifications to a task or the task details for a task can only be made by the task controller for the task and/or the administrator.

Our prior art search with abstracts described above teaches: a portable electronic device for assisting persons with learning disabilities and attention deficit disorders, a learning device for attention deficit children, a child's learning chair, an electronic timepiece with alarm and voice announcement function, an electronic reminder system, a portable alarm device, a system and method for motivating and reinforcing learning using a reward based learning toy, a voice activated personal organizer, a speech-controlled electronic apparatus, an electronic schedule display apparatus, an electronic equipment calendar and random daily message generator, a programmable toothbrush alarm unit, an apparatus to control diet and weight using human behavior modification techniques, a toy clock robot, an electronic assembly housing for alarm clocks, clock radios, table lamps or lights and toys, a design for a clock, a task management system, but does not teach a programmable timed action device that takes audio and visual signals to interface with a human in completing a task oriented schedule. The present invention fulfills these needs and provides further related advantages as described in the following summary.

### SUMMARY OF THE INVENTION

The present invention teaches certain benefits in construction and use which give rise to the objectives described below.

The present invention is an apparatus and method for executing a programmable timed action apparatus using audio and visual signals to interface with a human in completing a task oriented schedule includes the steps of: recording an expected set of audio and visual signals associated with at least one task; announcing the start of the task; receiving clue signals during the duration of the task; providing prompting during the duration of the task; checking for received feedback to the prompting; checking if a fixed task duration has timed out; announcing that the task is in overtime when the task has timed out; checking if the task is completed; and announcing status of the task.

A primary objective of the present invention is to provide an apparatus and method of use of such apparatus that provides advantages not taught by the prior art.

Another objective is to provide such an invention capable of monitoring a subject during the execution of a task or set of tasks.

A further objective is to provide such an invention capable of providing audible and visual announcements in accordance with monitored signals.

A still further objective is to provide such an invention capable of increasing the level of aggressive announcements depending on subject feedback and also monitored audible and visual signals in the vicinity of the apparatus.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention and method. In such drawings

FIG. 1 is a perspective view of one preferred embodiment of the invention;

FIG. 2 is a logic flow diagram representing a preferred programmed instruction set operative in the invention; and

FIG. 3 is a block diagram of the invention showing signal path from left to right.

### DETAILED DESCRIPTION OF THE INVENTION

The above described drawing figures illustrate the invention in at least one of its preferred embodiments, which is further defined in detail in the following description.

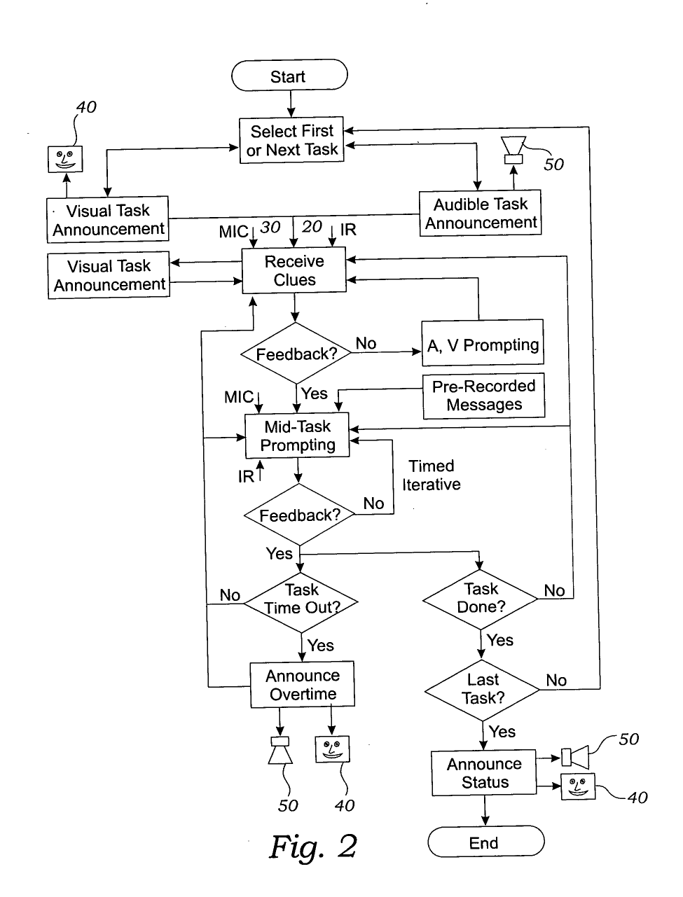

The present invention is an electronic apparatus and its method of use, wherein the apparatus includes an information processor device including a memory storage device 10, such as a microprocessor, and is thus able to process an instruction set contained within the memory device solid state domains. The apparatus provides at least one: visual sensor device (IR motion sensor) 20; audio sensor device (high gain microphone) 30; visual output device (LCD monitor) 40; audio output device (loudspeaker) 50; timing device (internal clock part of the information processor device 10); and a schedule of tasks including task name, start time and fixed expected duration of each of the plural tasks. The schedule of tasks is contained within the memory device solid state domains. The process instruction set, or program, defined in the block diagram of FIG. 2, includes a means for selecting each said one of the plural tasks, and in turn for each said task, audibly and visually announcing a start of task, seeking audio and visual clues as to the progress of task, presenting audio and visual prompts as to status of task, receiving audio feedback to prompts, testing as to end of fixed task duration, presenting overtime announcements after task duration timeout, and presenting audio and visual status information at the completion of the task. The means for operating the process instruction set and the set itself are well known aspects of the prior art and may be easily facilitated by ordinary computer programmers. The forgoing set of means are part of the operating program stored in the instruction set previously mentioned. The apparatus and method of the present invention are novel with respect to the specific approach and especially the characteristic of interfacing with a human subject to acquire an understanding of the status of the tasks as the schedule proceeds. Such interfacing is accomplish by actively receiving verbal comments from the subject as well as by listening and visually monitoring the local vicinity. This last capability and its integration into the step by step program control underlie the basis for the novelty of the present invention.

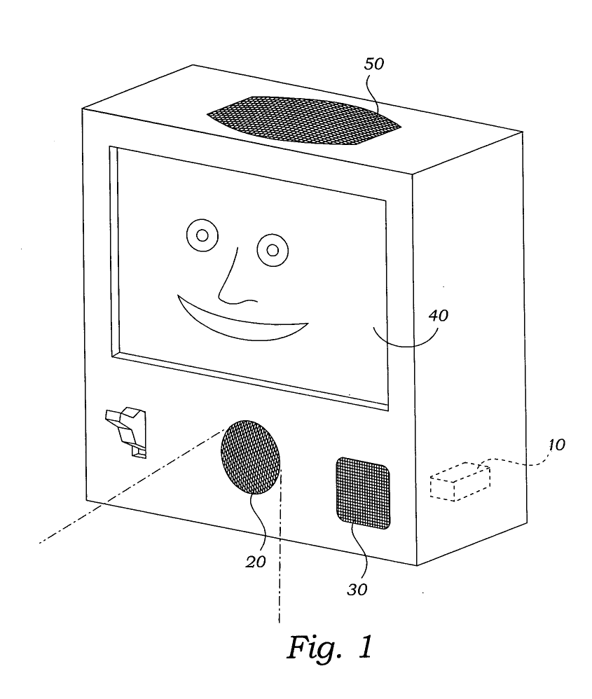

The method of the present invention is best illustrated by an example and may be followed to understand the nature of the process instruction set and the distinctions in the present invention with respect to the prior art. Referring now to FIG. 2, we see that the instruction set includes a means for selecting each one of the plural tasks that are to be monitored and managed. For simplicity, the present discussion deals with tasks that are in closed sequence, that is, one task is completed prior to the next task starting. However, the present instruction set and its method may be applied to tasks that are not sequential and parallel processing of tasks is simply a matter of adaptation of the program set. Those of skill in the art would have no trouble in elaborating the present program to handle tasks that are performed in parallel or which overlap in time by simply applying the steps defined in FIG. 1 for each task, and maintaining attention to each task independently of the others.

Therefore, for each task, an audible and visual announcement of the task initiates the start of the fixed task duration of the task. The instruction set then waits for the receipt of clues as to progress, that is, indications of motion and sound within the vicinity of the invention apparatus and as picked up via the microphone and infrared sensor devices. The visual and audible sensors, converted into digital signals by use of common A/D stages and fed to the information processor. Now, assuming the task list includes: getting out of bed, removing pajamas, brushing teeth and getting dressed; for the first task, the sensors pick up activity and motion in the vicinity when the subject arises from bed, i.e., the particular sound of a particular bed when getting up from the bed, and motion, detected in a particular sector of the room. In this case, feedback is satisfied. If the start of this task is announced and after a set delay no activity, or insufficient activity, is sensed, audible and visual prompting is initiated. Such prompting preferably includes audible (synthesized voice) and visual display activity and, in the present situation may include a audible prompt such as, “Tommy, it's time to get out of bed dear,” presented by the loud speaker 50. A voice synthesizer may be used to create the audio “voice” outputs, or they may be merely digitally recorded sound “bites.” A visual prompt corresponding to this voice prompt might be the presentation of a smiling face on a liquid crystal display monitor 40, or other visual display device. In an alternate embodiment, the audio and visual outputs may be sent to a television set for enablement, or the present invention may be integral to a television set, CD or DVD player or other electronic equipment. The sensing of further inactivity on the part of Tommy would induce further audio and visual prompting of a more aggressive nature depending on how long the inactivity persists and such ramping-up of prompting may be programmed as to the steepness of the ramp and the level of aggressiveness. These factors are best left to the user, but the ability to set-up such programmed initialization in the apparatus would be a matter of routine enablement by those of skill in the art.

An important and critical aspect of the present invention is the use of a base set of sensory information. In the present case, the base set is recorded digitally the first time the set of tasks are performed. For instance, what is the sound and visual expectations of Tommy getting out of bed? These are determined by conducting the identified task while setting the apparatus to a recoding mode. Thus, later when the same task is requested, the actual visual and audible activity within the room is compared to the base recorded version. Such comparison may be merely a comparison of a gross level of activity, or may be a full frequency domain comparison of the most rich frequency channels. Whatever the method of comparison and need for accuracy in determining task compliance, it is well within the scope of the electronics engineer to provide comparison of digitized information from audio and visual sensors at two different occasions (initial and actual).

Mid-task prompting takes the form of announcements from the apparatus, via loud speaker. Such announcements may include identification of the percent of time that has expired from the start of the task, with respect to the fixed task duration. It may also include encouragement and motivational elements, such as, “I'm sure you are doing a good job,” or “Hurry now, you only have five minutes left to complete this task.” Such comments may be stored as prerecorded digital messages and may be called randomly when appropriate.

When such prerecorded messages constitute a question, such as, “How are you doing, are you out of the bathroom yet?,” the instruction set moves to a portion of the program wherein verbal audible feedback is expected. When this is not received, further prompting is initiated and at a higher level of aggression until the feedback is received. This is marked as “timed iterative” in FIG. 1. Preferably, the invention apparatus is trained to “understand” at least a few words spoken within the vicinity of the apparatus. Words such as “yes,” “no,” “okay” and so on are easily programmed into the memory of the apparatus and using well known voice recognition techniques, these feedback signals from the subject are able to maintain a constant link between machine and human. If the program expects a “yes” or “no” answer it will prompt with, “I did not understand that, please repeat it” if detection of an unrecognizable response is received, and will respond appropriately when a recognized response is receive, as for example, “Oh, that means your right on track, good going.”

If the fixed time duration of a task times-out prior to the subject announcing completion, an overtime announcement is made and the program resumes its search for audio and visual clues. If the task is announced as being completed by the subject, the program moves to the next task in the sequence. If the last task is completed, an announcement is made with informational and motivational content. Examples of such announcements are as follows:

“Great! You got ready to go to breakfast very fast today. You earned 10 points and now have a total of 245 points. When you reach 300 points you can trade them in for an extra hour of television on Friday night. Good going.”

“Nice job! You were a little slow this morning, but still within acceptable time. You earned 2 points and now have a total of 12 points. Tomorrow I'm sure you will do better.”

“Well you were pretty slow this morning. You didn't earn any points. Better luck tomorrow. Have a nice day.”

Visual effects correspond with a bright smiling face, a slightly smiling face and a sad face respectively.

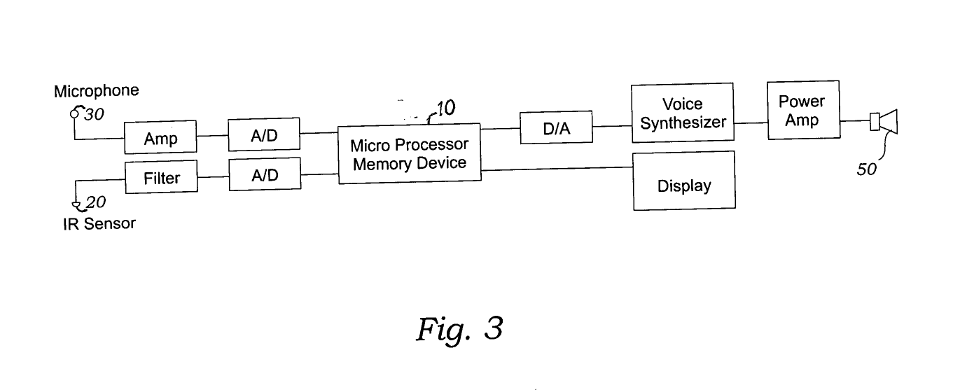

Clearly, the programming of the apparatus and its operation comprise a number of well known circuit elements, see FIG. 3, and program steps. One of the novelties of this program and machine-human interface is the creation of a task set with expected audio and visual inputs, the ability to take alternative output actions depending on the expectations and the ramping up of aggressive responses depending on the received (or non-received) inputs.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. An electronic apparatus comprising: at least one information processor device including a memory storage device; a process instruction set supported by the memory device; at least one: visual sensor device; audio sensor device; visual output device; audio output device; timing device; and schedule of tasks including task name, start time and expected duration of each of plural tasks; the information program including means for selecting each said one of the plural tasks, and in turn for each said task, audibly and visually announcing a start of task, seeking audio and visual clues as to a progress of task, presenting audio and visual prompts as to status of task; and presenting audio and visual information at the completion of at least one of the expected duration and the actual completion of task.

2. The apparatus of claim 1 further comprising a means for comparing a record-mode set of audio and visual clues with a real-time set of such clues.

3. The apparatus of claim 1 further comprising a set of prerecorded announcement messages.

4. A method for executing a programmable timed action apparatus using audio and visual signals to interface with a human in completing a task oriented schedule comprising the steps of: recording an expected set of audio and visual signals associated with at least one task; announcing the start of the task; receiving clue signals during the duration of the task; providing prompting during the duration of the task; checking for received feedback to the prompting; checking if a fixed task duration has timed out; announcing that the task is in overtime when the task has timed out; checking if the task is completed; and announcing status of the task.

5. The method of claim 4 further comprising the step of prerecording announcement messages.

6. The method of claim 4 further comprising the step of comparing the received signals associated with a task during the execution of the task with the prerecorded signals of the task.

7. The method of claim 6 further comprising the step of selecting an announcement in accordance with the results of the comparing step.
